(19) United States
(12) Patent Application Publication
(10) Pub. No.: US 2025/0363458 A1
(43) Pub. Date: Nov. 27, 2025

(54) SYSTEMS AND METHODS FOR TRANSFERRING ARTIFICIAL INTELLIGENCE (AI) AGENTS

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,265

(22) Filed: May 22, 2025

(30) Foreign Application Priority Data
May 22, 2024 (IN) 202311079240

(51) Int. Cl. G06Q 10/10; G06F 11/34

(52) U.S. Cl. CPC G06Q 10/103; G06F 11/3409

(57) ABSTRACT

System and method for managing collaboration of Artificial Intelligent (AI) agents within a secure enclave are disclosed. The method comprises receiving, by an AI agent, a collaboration request to communicate with a transfer AI agent within the secure enclave. The AI agent logs the collaboration request with initial parameters and a state of the AI agent in a database associated with the secure enclave. The AI agent transmits the collaboration request to the transfer AI agent within the secure enclave. The transfer AI agent analyses the data, and the context associated with the collaboration request to generate inferences and potential solutions. The transfer AI agent transmits the generated inferences and potential solutions to the AI agent to execute, by the AI agent, an action to the collaboration request based on the generated inferences and potential solutions.

### CROSS-REFERENCE TO RELATED APPLICATIONS

This patent application claims priority to Indian Patent Application No. IN 202311079240, filed May 22, 2024, entitled “SYSTEMS AND METHODS FOR TRANSFERRING ARTIFICIAL INTELLIGENCE (AI) AGENTS,” and assigned to the assignee hereof. The disclosure of the prior application is considered part of and is incorporated by reference in this patent application.

### TECHNICAL FIELD

Embodiments of the present disclosure generally relate to data management systems and more particularly to systems and methods for transferring artificial intelligence (AI) agents.

### BACKGROUND

In the domain of transferable AI agents, a central challenge revolves around optimizing the transfer process and ensuring the seamless adaptation of these agents to new contexts and tasks. While the concept of transferability offers great promise, it brings with it a set of intricate issues that need to be effectively addressed to maximize the potential of these agents in diverse applications. The foremost challenge is the development of highly efficient transfer learning techniques that enable Transferable AI agents to adapt swiftly and effectively when moved from one context to another. Transferable AI agents must be capable of deeply understanding the nuances and specificities of new contexts. Adapting to different environments or domains requires more than just the transfer of knowledge; it demands the acquisition of a profound comprehension of the target context's unique challenges and requirements. Transferable AI gents must adapt to dynamic and ever-changing environments where circumstances shift rapidly. Ensuring that they can make real-time decisions and remain current in volatile conditions is a critical problem to solve. Further, ensuring that transferable AI agents evolve and improve over time as they engage in diverse contexts is a vital aspect of their long-term effectiveness.

Consequently, there is a need for improved systems and methods for transferring artificial intelligence (AI) agents, to address at least the aforementioned issues of the prior arts.

### OBJECTS OF THE INVENTION

A general objective of the present disclosure is to provide a system and a method for managing collaboration of a plurality of Artificial Intelligent (AI) agents within a secure cloud-based enclave. The further objectives of present disclosure are discussed below.

Another objective of the present disclosure is to mitigate problem of AI rigidity, siloed expertise, and resource underutilization.

Another objective of the present disclosure is to provide a method of logging interactions within the AI environment.

Another objective of the present disclosure is to utilize multi-layered interaction logs as a dynamic training resource.

Yet another objective of the present disclosure is to provide high quality data AI training

Still another objective of the present disclosure is to facilitate the controlled deployment and evaluation of newly trained or refined AI models.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for managing collaboration of a plurality of Artificial Intelligent (AI) agents within a secure cloud-based enclave. The method comprises receiving, by an AI agent of the plurality of AI agents, a collaboration request to communicate with a transfer AI agent within the secure cloud-based enclave. The collaboration request comprises initial parameters and a state of the AI agent. The method further comprises logging, by the AI agent, the collaboration request with initial parameters and a state of the AI agent in a database associated with the secure cloud-based enclave. The method further comprises transmitting, by the AI agent, the collaboration request with data and context to the transfer AI agent within the secure cloud-based enclave. The method further comprises adapting, by the transfer AI agent, operational context associated with the collaboration request to register accessed knowledge sources and configuration changes. The method further comprises analysing, by the transfer AI agent using a first AI model deployed within the secure cloud-based enclave, the data and the context associated with the collaboration request to generate inferences and potential solutions. The method further comprises transmitting, by the transfer AI agent, the generated inferences and potential solutions to the AI agent in response to the collaboration request. The method further comprises executing, by the AI agent, an action to the collaboration request based on the generated inferences and potential solutions.

In an aspect of the present invention, the data and context associated with the collaboration request comprise data packets, metadata, sender/receiver identifiers, and timestamps.

In an aspect of the present invention, the method further comprises obtaining, by the transfer AI agent, input from one or more users based on an external interaction, wherein the input from the one or more users comprises at least one of a feedback, adjustments, and final decision related to the collaboration request and fine-tuning, by the transfer AI agent, the inferences and potential solutions based on the input obtained from the one or more users.

In an aspect of the present invention, the method further comprises obtaining, by the transfer AI agent, accumulated multi-layered historical logs from the database associated with secure cloud-based enclave, wherein the accumulated multi-layered historical logs comprise at least one of facts, inferences, behavioural data, and feedback loops obtained from past interactions and fine-tuning, by the transfer AI agent, the inferences and potential solutions based on the accumulated multi-layered historical logs.

In an aspect of the present invention, the method further comprises deploying a second AI model along with the first AI model within the secure cloud-based enclave, analysing, by the transfer AI agent using the second AI model, the data and the context associated with the collaboration request to generate the inferences and potential solutions, comparing performance of the second AI model with performance of the first AI model based on an analysis of results generated by the second AI model and the first AI model, and prioritizing the second AI model over the first AI model based on a determination the performance of the second AI model is better than the performance of the first AI model.

In an aspect of the present invention, the method further comprises identifying a redundant AI agent from the plurality of AI agents based on performance of each AI agent of the plurality of AI agents, archiving knowledge and critical interaction history from the redundant AI agent, and deconstructing the redundant AI agent from the plurality of AI agents after archiving knowledge and critical interaction history from the redundant AI agent.

In an aspect of the present invention, the secure cloud-based enclave securely retains the user data within the database without directly exposing to an external AI system.

In another embodiment, the present invention discloses a system for managing collaboration of a plurality of Artificial Intelligent (AI) agents within a secure cloud-based enclave. The system comprises one or more processors associated with a plurality of AI agents. The system further comprises a memory storing programmed instructions executable by the one or more processors. The one or more processors execute the programmed instructions to receive, by an AI agent of the plurality of AI agents, a collaboration request to communicate with a transfer AI agent within the secure cloud-based enclave. The collaboration request comprises initial parameters and a state of the AI agent. The one or more processors are further configured to log, by the AI agent, the collaboration request with initial parameters and a state of the AI agent in a database associated with the secure cloud-based enclave. The one or more processors are further configured to transmit, by the AI agent, the collaboration request with data and context to the transfer AI agent within the secure cloud-based enclave. The one or more processors are further configured to adapt, by the transfer AI agent, operational context associated with the collaboration request to register accessed knowledge sources and configuration changes. The one or more processors are further configured to analyse, by the transfer AI agent using a first AI model deployed within the secure cloud-based enclave, the data and the context associated with the collaboration request to generate inferences and potential solutions. The one or more processors are further configured to transmit, by the transfer AI agent, the generated inferences and potential solutions to the AI agent in response to the collaboration request. The one or more processors are further configured to execute, by the AI agent, an action to the collaboration request based on the generated inferences and potential solutions.

### BRIEF DESCRIPTION OF THE DRAWINGS

The disclosure will be described and explained with additional specificity and detail with the accompanying figures in which:

FIG. 1 illustrates an exemplary block diagram representation of network architecture implementing a system for transferring artificial intelligence (AI) agents, in accordance with an embodiment of the present disclosure;

FIG. 2 illustrates an exemplary block diagram representation of a computer implemented system, such as those shown in FIG. 1, capable of transferring artificial intelligence (AI) agents, in accordance with an embodiment of the present disclosure;

FIG. 3 illustrates an exemplary flow diagram representation of interaction between transfer AI agent and other AI agents, in accordance with an embodiment of the present disclosure; and

FIG. 4 illustrates a flow chart of a method for managing collaboration of a plurality of Artificial Intelligent (AI) agents within a secure cloud-based enclave, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for transferring artificial intelligence (AI) agents.

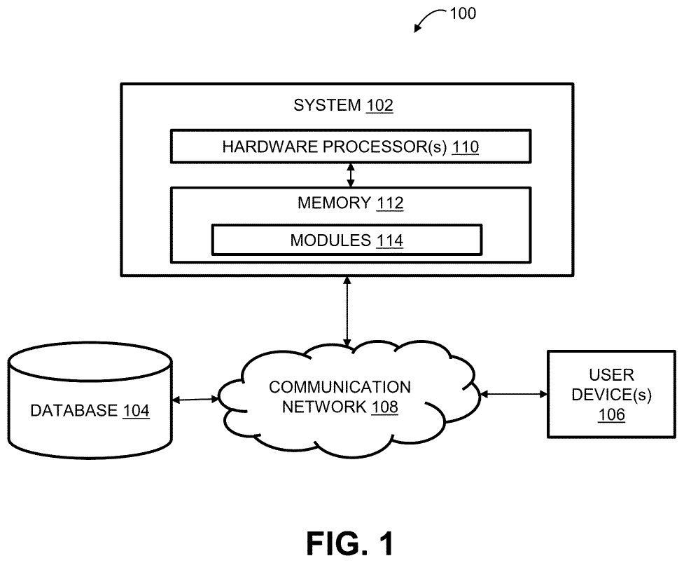

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system for transferring artificial intelligence (AI) agents, in accordance with an embodiment of the present disclosure. According to FIG. 1, the network architecture 100 includes the system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, transfer data, inference data, context data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for transferring artificial intelligence (AI) agents need. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for transferring artificial intelligence (AI) agents. Execution of the machine-readable program instructions by the hardware processor 110 may enable the proposed system 102 to transfer artificial intelligence (AI) agents. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may transfer AI agents to different contexts or environments at any stage of the training process. Unlike traditional AI agents, which are confined to specific tasks and environments, the AI agents may adapt and thrive in diverse scenarios without requiring full retraining.

In an exemplary embodiment, the system 102 may collaborate with inference-generating agents transferable AI agents. The system 102 may generate valuable inferences for other AI agents. This collaborative approach fosters distributed problem-solving, enabling multiple agents to work together effectively by sharing insights and knowledge.

Transferability during training, may include at any point during the training process of this AI agent, the system 102 has the capability to transfer or move the agent to a different context or environment. In traditional machine learning or AI training, agents are typically trained in a specific environment and for specific tasks, and they do not easily adapt to new contexts or tasks. Transferable AI agents, on the other hand, can be moved from one environment to another without requiring a complete retraining process. This ability to transfer agents makes them versatile and adaptable to different scenarios.

Inference generation for other agents may use the transferable AI agents not only to perform tasks in their original environment but also to generate inferences or insights that can be valuable to other AI agents. These inferences can be shared with other agents in the system, allowing for collaborative and distributed problem-solving. This capability can be highly beneficial in scenarios where multiple AI agents need to work together to solve complex problems, leveraging the expertise and knowledge of one agent to aid others.

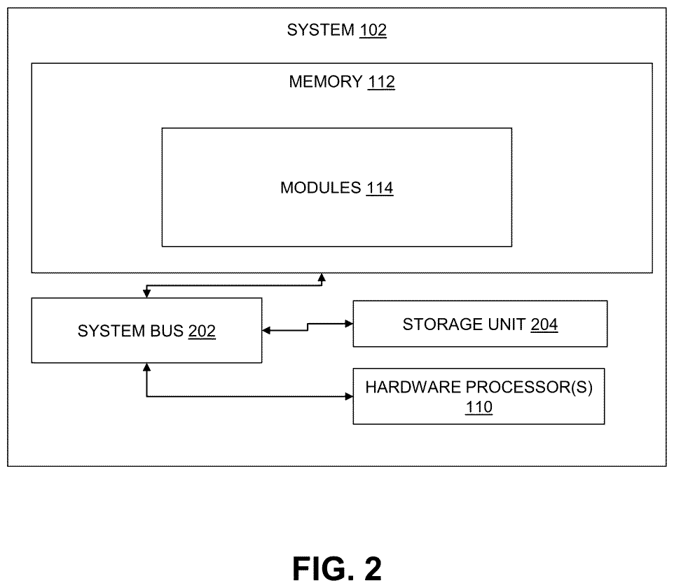

FIG. 2 illustrates an exemplary block diagram representation of a computer implemented system 102, such as those shown in FIG. 1, capable of transferring artificial intelligence (AI) agents, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, transfer data, inference data, context data, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may transfer AI agents to different contexts or environments at any stage of the training process. Unlike traditional AI agents, which are confined to specific tasks and environments, the AI agents may adapt and thrive in diverse scenarios without requiring full retraining.

In an exemplary embodiment, the plurality of modules 114 may collaborate with inference-generating agents transferable AI agents. The system 102 may generate valuable inferences for other AI agents. This collaborative approach fosters distributed problem-solving, enabling multiple agents to work together effectively by sharing insights and knowledge.

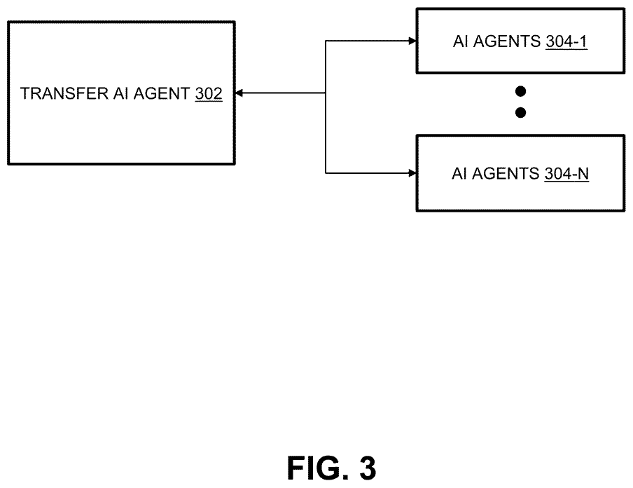

FIG. 3 illustrates an exemplary flow diagram representation of interaction between transfer AI agent 302 and other AI agents 304-1 to 304-N, in accordance with an embodiment of the present disclosure.

Transfer AI agents 302, on the other hand, represent a specialized category of AI agents. These agents are designed with a unique feature-transferability. Transferable AI Agents can seamlessly transition from one context or environment to another during their training or deployment. This adaptability allows them to excel in diverse scenarios without the need for extensive retraining, setting them apart from conventional AI agents. Furthermore, Transfer AI Agents are not only adept at their primary tasks but also possess the capability to generate valuable inferences and insights for other agents. This collaborative approach fosters efficient problem-solving in dynamic and complex environments, making Transfer AI Agents particularly valuable in scenarios that demand versatility, adaptability, and collaborative intelligence.

AI agents 304 are software programs designed to perform tasks and make decisions using various artificial intelligence techniques. These agents have a broad range of applications, spanning from simple rule-based systems to complex neural networks. AI agents can be employed in tasks such as natural language processing, image recognition, recommendation systems, and even game playing. They are capable of tackling various challenges, but not all AI agents possess the ability to easily adapt to different contexts or tasks without undergoing significant retraining.

In an exemplary embodiment, transferring of agents can also be body language, voice, tones, style, dressing sense, 3d entities and mappings.

In an exemplary embodiment, transferring of agents can also be partial transfer of the agent and may be limited by part for example by time, category, and context, engagement with other agents, and brand/agent safety.

The interaction between Transfer AI agents 302 and conventional AI agents 304 is marked by a cooperative and supportive relationship, enabling enhanced problem-solving and adaptability in various contexts. When a complex or unfamiliar situation arises that a conventional AI agent cannot handle independently, it can reach out to a Transfer AI agent 302 for assistance, initiating a collaborative problem-solving process. In this interaction, the Transfer AI agent 302 may gather data, observations, or local insights from the requesting conventional AI Agent. The Transfer AI Agent's adaptability and data analysis capabilities allow it to consolidate and analyze this information, resulting in a comprehensive understanding of the problem. It can then generate valuable inferences, insights, or recommendations based on the aggregated data from multiple conventional AI Agents, significantly enhancing the decision-making process.

The communication between these agents is bidirectional, with the Transfer AI Agent providing feedback, insights, or recommendations back to the requesting conventional AI agents. This feedback guides the actions of the conventional agents, helping them address the problem more effectively. Additionally, transfer AI agents can take on specific tasks or subtasks, relieving the conventional AI Agents when their expertise or adaptability is required for a particular task. Transfer AI Agents are designed for adaptive learning, enabling them to improve their problem-solving abilities over time based on the experiences and insights gained during collaborations with conventional AI Agents. This adaptive learning ensures that they become even more effective as they encounter a wider range of scenarios.

In dynamic environments, Transfer AI Agents provide real-time decision support, assisting conventional AI Agents in navigating complex and evolving situations. Continuous monitoring is a key aspect of this interaction, allowing both Transfer AI Agents and conventional AI Agents to assess the effectiveness of their actions and adjust their strategies as needed to ensure optimal performance. The synergy between Transfer AI Agents and conventional AI Agents exemplifies the potential of collaborative artificial intelligence, with Transfer AI Agents augmenting the capabilities of their counterparts to address complex and dynamic challenges effectively. The specific nature of their interaction may vary depending on the application, but the overarching goal is to improve adaptability, problem-solving, and decision-making in various contexts.

The present invention outlines an innovative and detailed method for the process and interaction flow within a secure cloud-based enclave. It focuses on the interaction between a transfer AI agent 302 and other AI agents 304-1 to 304-N as depicted in FIG. 3, and critically, incorporates the capability to leverage comprehensively logged interactions for continuous AI model evolution and lifecycle management.

An AI agent 304 may encounter a scenario requiring collaboration. Initial parameters of the request and the state of AI agent 304 are logged (facts, behavioral markers). The AI agent 304 may formulate and securely transmit its request, including data and context, to the transfer AI agent 302 within the secure cloud-based enclave. All aspects of this request transmission (data packets, metadata, sender/receiver identifiers, timestamps) are logged as factual and behavioral data.

The transfer AI agent 302 may adapt its operational context. The adaptation process, including accessed knowledge sources and configuration changes, may be logged. The transfer AI agent 302 may gather and analyze data from the requesting agent(s). The transfer AI agent 302 may generate inferences and potential solutions. The raw data processed, the analytical steps, the inferences generated (even preliminary ones), and the confidence scores are logged.

The transfer AI agent 302 communicates its findings (inferences, recommendations) back to AI agent 304. If user interaction is involved (e.g., a clinician reviewing a diagnosis), their feedback, adjustments, or final decisions are also captured. The full response, any subsequent clarifications, and all user/agent feedback are logged, creating a complete record of the collaborative decision-making process (facts, inferences, and behavioral feedback).

Further, the AI agent 304 utilizes the guidance provided by the transfer AI agent 302. The actions taken by the AI agent 304 and the observed outcomes may be logged in the storage unit 204 (also referred to as a database 204). Within the secure cloud-based enclave, the accumulated multi-layered logs (facts, inferences, behavioral data, and feedback loops) from numerous past interactions may be utilized. These rich historical interaction sequences may be “replayed” as training scenarios for a new generation of AI models or for significantly upgrading existing ones. This allows the new model to learn from the collective intelligence and nuanced experiences of the entire system. This process is particularly powerful as it captures not just explicit data, but also implicit knowledge embedded in interaction patterns and feedback.

In an exemplary embodiment, a newly trained model (e.g., Model B) can be deployed alongside an existing model (Model A) within the secure cloud-based enclave. A subset of requests may be routed to Model B, and its performance (accuracy, efficiency, and user satisfaction based on logged feedback) may be compared quantitatively against Model A. When a major system upgrade is planned, new models trained on historical interaction data may be pre-validated in the new environment, ensuring a smoother transition and minimizing disruption. The transferred knowledge from past interactions helps the new system get up to speed quickly.

Once the new model is validated and deployed, and its performance surpasses older models, a secure deconstruction process for the outdated agents may be initiated. This involves ensuring all unique knowledge and critical interaction history from the old agent have been successfully assimilated or are no longer relevant. The deconstruction process itself may be managed securely within the secure cloud-based enclave, ensuring that sensitive data remnants are properly sanitized or destroyed according to predefined policies. This prevents data leakage and optimizes resource utilization.

In an exemplary embodiment, the system 102 may utilize secure protocols for communication between the AI agents 304 and the transfer AI agent 302. Such protocols may include, but not be limited to, Transport Layer Security/Secure Sockets Layer (TLS/SSL), HyperText Transfer Protocol Secure (HTTPS), OAuth 2.0, mutual TLS (mTLS), secure messaging, Remote Procedure Calls (RPC) with TLS, encryption at rest, network segmentation, and secure key management. Such communication protocol provides robust and tamper-proof logging mechanisms. Logs must be encrypted, timestamped, and have strong integrity checks. Access to the interaction logs for replay and training must be strictly controlled and audited, even within the secure cloud-based enclave, to maintain privacy and security. When replaying interactions for training, if any part of the data is particularly sensitive and not essential in its raw form for model learning, on-the-fly sanitization or anonymization techniques might be applied according to policies of the secure cloud-based enclave.

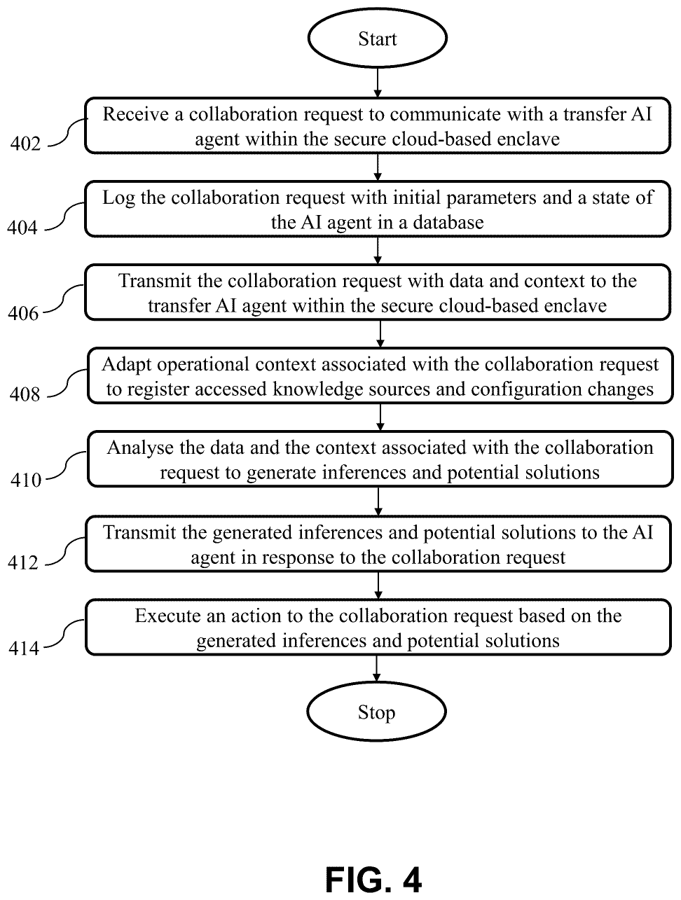

FIG. 4 illustrates a flow chart of a method 400 for managing collaboration of a plurality of AI agents within a secure cloud-based enclave, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, an AI agent 304 of the plurality of AI agents may receive a collaboration request to communicate with the transfer AI agent 302 within the secure cloud-based enclave. The collaboration request comprises initial parameters and a state of the AI agent 304. The secure cloud-based enclave securely retains the user data within the database without directly exposing to an external AI system.

At block 404, the AI agent 304 logs the collaboration request with initial parameters and a state of the AI agent 304 in a database associated with the secure cloud-based enclave. At block 406, the AI agent 304 transmits the collaboration request with data and context to the transfer AI agent 302 within the secure cloud-based enclave. The data and context associated with the collaboration request may comprise data packets, metadata, sender/receiver identifiers, and timestamps.

At block 408, the transfer AI agent 302 may adapt operational context associated with the collaboration request to register accessed knowledge sources and configuration changes. At block 410, the transfer AI agent 302 may analyse the data and the context associated with the collaboration request to generate inferences and potential solutions. The data and the context may be analysed using a first AI model deployed within the secure cloud-based enclave.

At block 412, the transfer AI agent 302 may transmit the generated inferences and potential solutions to the AI agent 304 in response to the collaboration request. At block 412, the transfer AI agent 302 may execute an action to the collaboration request based on the generated inferences and potential solutions.

In an exemplary embodiment, the transfer AI agent 302 may obtain input from one or more users based on an external interaction. The input from the one or more users comprises at least one of a feedback, adjustments, and final decision related to the collaboration request. Further, the transfer AI agent 302 may fine-tune the inferences and potential solutions based on the input obtained from the one or more users.

In an exemplary embodiment, the transfer AI agent 302 may obtain accumulated multi-layered historical logs from the database associated with secure cloud-based enclave. The accumulated multi-layered historical logs comprise at least one of facts, inferences, behavioural data, and feedback loops obtained from past interactions. Further, the transfer AI agent 302 may fine-tune the inferences and potential solutions based on the accumulated multi-layered historical logs.

In an exemplary embodiment, the transfer AI agent 302 may deploy a second AI model along with the first AI model within the secure cloud-based enclave. Further, the transfer AI agent 302 may analyze the data and the context associated with the collaboration request to generate the inferences and potential solutions using the second AI model. The transfer AI agent 302 may compare performance of the second AI model with performance of the first AI model based on an analysis of results generated by the second AI model and the first AI model. Furthermore, the transfer AI agent 302 may prioritize the second AI model over the first AI model based on a determination the performance of the second AI model is better than the performance of the first AI model.

In an exemplary embodiment, the transfer AI agent 302 may identify a redundant AI agent from the plurality of AI agents based on performance of each AI agent of the plurality of AI agents. Further, the knowledge and critical interaction history may be archived from the redundant AI agent. The system 102 may further deconstruct the redundant AI agent from the plurality of AI agents after archiving knowledge and critical interaction history from the redundant AI agent.

In an example, evolving secure medical diagnosis assistance may be explained. For initial interaction, the AI agent 304 (EHR AI) may request help from the transfer AI agent 302 for a complex case. All communications, data shared (symptoms, history), inferences from the transfer AI agent 302, and critically, the clinician's final diagnosis, chosen treatment, and notes on why they agreed or diverged from the transfer AI agent 302 suggestions are logged securely with timestamps and contextual metadata (fact, inference, behavioral, and feedback).

For training of new AI model, in several months, thousands of such diagnostic interactions (including clinician feedback and patient outcomes where available and authorized) have been logged. Within the secure cloud-based enclave, a dedicated training module replays these interactions. A new version of the transfer AI agent's diagnostic model (may be referred to as DiagnosticModel_v2) is trained using this rich dataset. It learns from cases where its predecessor was correct, where clinicians provided crucial additional insights, and from observed patient outcomes linked to different diagnostic paths.

For testing DiagnosticModel_v2, the DiagnosticModel_v2 may be deployed in the secure cloud-based enclave alongside the current version (DiagnosticModel_v1). For the next 100 complex neurology cases, 50 are randomly assigned to receive assistance from DiagnosticModel_v1 and 50 from DiagnosticModel_v2. The system 102 logs the quality of suggestions, clinician agreement rates (via feedback), and time-to-diagnosis. In a scenario of current example, results may show that DiagnosticModel_v2 has a 15% higher clinician agreement rate and suggests more accurate further tests than DiagnosticModel_v1. Thus, DiagnosticModel_v2 becomes the primary model. The interaction logs that formed the basis of DiagnosticModel_v1's unique learning (if any elements were not fully captured by DiagnosticModel_v2's training set) are reviewed. If all knowledge is deemed transferred or superseded, a secure deconstruction protocol is initiated for DiagnosticModel_v1. This involves wiping its specific instances and parameters from the system, with auditable proof of destruction, as per the enclave's data lifecycle and security policies.

### Exemplary Scenario 1

Consider, a context of a smart city with a complex autonomous vehicle traffic management system, transfer AI agents 302 and conventional AI agents 304 engage in a collaborative interaction process. The conventional AI Agents, installed in autonomous vehicles, continuously collect data about traffic conditions, obstacles, and pedestrian movements, processing this information to make local decisions, such as identifying traffic congestion or road obstacles. However, when they encounter complex scenarios beyond their capabilities, such as unexpected traffic jams, they send out collaboration requests.

These collaboration requests may be received by the transfer AI agent 302, specifically designed for traffic optimization and management in the smart city. The transfer AI agent 302 possess a crucial feature-adaptability. They promptly adapt to the situation and collect data from multiple AI agents in the affected area. By fusing this data, the transfer AI agent 302 gains a comprehensive understanding of the situation, enabling it to make real-time decisions to alleviate the traffic congestion. This could involve actions like rerouting vehicles or controlling traffic lights to mitigate the issue.

The transfer AI agent 302 communicates these decisions back to the requesting a local AI agent 304 in the vehicle, providing guidance on how to navigate the situation effectively. The local AI agent 304 then implements this guidance, helping the vehicle navigate through the traffic jam safely and efficiently. Throughout this collaborative process, both transfer AI agent and conventional AI agents continuously monitor the situation, adjusting their actions as needed to ensure the smooth flow of traffic and the safety of the city's residents.

This interaction process showcases the synergy between the transfer AI agents 302 and conventional AI agents, where adaptability, data fusion, and decision-making capabilities of the transfer AI agents enhance the overall effectiveness of the traffic management system in a dynamic and complex smart city environment. It exemplifies how such agents can collaborate to address real-time challenges, ensuring the optimal functioning of autonomous vehicle systems and the well-being of the city's inhabitants.

### Exemplary Scenario 2

Consider, a scenario of enhancing medical diagnosis with the transfer AI agent 302. A dedicated general practitioner faces a challenging medical case. His patient presents a rare and complex set of symptoms that fall outside the realm of routine general practice. In such situations, the capabilities of the transfer AI agents are instrumental in reaching a timely and accurate diagnosis. The transfer AI agent 302 involved in this scenario serves as a versatile diagnostic assistant. Its key attributes include the ability to seamlessly transfer to various medical specialties during training and the capacity to generate insightful inferences independently for other agents, in this case, healthcare professionals such as general practitioner.

When general practitioner encounters a particularly complex case, he initiates a transfer request to the transfer AI agent 302, providing details of the patient's symptoms and medical history. The transfer AI agent 302 then promptly transitions to a specialized medical context that is pertinent to the patient's condition, such as neurology. Once in the specialized context, the transfer AI agent 302 meticulously analyzes the patient's data and symptoms, generating inferences that contribute to narrowing down possible diagnoses. These inferences are then shared with the general practitioner, offering suggestions for potential diagnoses and recommending further tests or diagnostic procedures.

The interaction between general practitioner and the transfer AI agent 302 results in collaborative decision-making. In partnership with the AI agent 304, the general practitioner carefully evaluates the information, considers the various diagnostic possibilities, and decides on the most appropriate course of action. This could include additional testing, referrals to specialists, or the initiation of immediate treatment. As a comprehensive patient care plan is devised, the transfer AI agent's insights prove invaluable. The general practitioner may utilize the collaborative diagnosis and recommendations to formulate a tailored approach to patient care. This may involve consultations with specialists, further diagnostic work, or the initiation of a specific treatment regimen.

In the background, the transfer AI agent 302 continues to learn and improve its diagnostic capabilities with each interaction. The agent's adaptive learning process ensures it becomes more effective in diagnosing complex cases as it gains experience in different medical contexts. This scenario exemplifies how the transfer AI agents 302 can significantly enhance the diagnostic capabilities of medical practitioners, leading to more accurate and timely diagnoses, improved patient outcomes, and more effective decision-making in the complex and dynamic field of healthcare.

The present invention relates to providing a method and a system for managing collaboration of a plurality of AI agents within the secure cloud-based enclave. Traditional AI agents are often designed for narrow tasks and specific contexts. They lack the flexibility to adapt to new or related domains without significant re-engineering or retraining, making them inefficient for diverse, evolving problem sets. Present invention allows a single agent architecture to be versatile across multiple domains. Further, conventional AI techniques require broad access to data, which poses a significant challenge when dealing with private, confidential, or regulated information (e.g., personal health information, financial data). The present invention addresses how a highly adaptable AI can operate effectively and securely within a controlled environment, ensuring data privacy and integrity.

Further, deploying and maintaining separate, specialized AI agents for every conceivable task or context is resource-intensive (computationally and financially). A transfer agent that can adapt its context minimizes the need for numerous single-purpose agents.

Conventional AI systems, especially complex ones, operate as black boxes, making it difficult to understand their decision-making processes. This detailed logging provides a rich audit trail, enhancing transparency and debuggability. Furthermore, standard logs often lack the contextual depth needed to train AI models that can understand nuances, improve from subtle feedback, or replicate complex reasoning. This multi-layered approach provides a much richer dataset. In critical applications, it's vital to have a thorough record of AI behavior. The present invention creates a comprehensive record far beyond simple event logs, enabling better auditing and accountability.

The present invention provides a mechanism for continuous learning and adaptation based on ongoing, real-world interactions. This overcomes degradation of AI models in performance over time or fails to adapt to new patterns not seen in their initial training. Further, the present invention turns the system's operational data into a valuable, evolving training asset. The present invention allows for the effective transfer of this implicit knowledge to new generations of models when an AI model is updated or replaced, its “learned experiences” can be lost.

The present invention further provides A/B testing that mitigates a risk of unexpected errors, performance degradation, or negative user experiences during deployment of a new AI model. Further, the present invention provides a framework for empirical comparison and validation to mitigate difficult to objectively demonstrate that a new AI model is superior to its predecessor. The present invention allows for a phased and validated rollout, ensuring the new system performs as expected or better in case of migration to the new AI architectures.

The present invention manages proliferation of AI agents, including outdated ones that can lead to inefficient resource use, increased attack surfaces, and unpredictable system behavior. Old AI agents may contain sensitive data or learned patterns that could be compromised if not securely decommissioned. The present invention addresses the need for secure data and model retirement. Further, the present invention ensures that the “wisdom” of past agents contributes to the evolving intelligence of the overall system before the agent is retired.

In an exemplary embodiment, the system 102 may capture the specific types of behavioral information, such as body language, voice, tones, style, dressing sense, 3d entities, and mappings as transferable aspects. Using the behavioral information, captured from potentially diverse interactions (even those involving 3D entities or vocal tones), as a core part of the replay and training data for new AI models is a significant leap. It allows successor models to learn not just what to do, but how to interact in a more human-like, contextually appropriate, or effective manner. This goes beyond traditional machine learning that primarily uses factual or labeled data.

In an exemplary embodiment, the present system provides a system where operational rules, privacy constraints, and ethical guidelines are translated into executable code within the enclave. This allows for real-time enforcement and adaptation of governance, ensuring that as agents evolve and interact, they remain compliant with complex and possibly changing requirements without constant manual intervention. This makes the enclave more than just a secure box; it's an actively governed ecosystem.

In an exemplary embodiment, the present invention provides a mechanism that allows the system to dissect an AI agent and transfer only specific, relevant components or capabilities tailored to a new context or a temporary need is a significant technical achievement. For instance, a customer service AI might have its “complaint resolution” module temporarily enhanced or transferred from a specialist “conflict resolution” Transfer AI agent, without transferring its entire knowledge base. This selective transfer optimizes efficiency, maintains security (by not over-exposing capabilities), and allows for highly tailored agent behavior.

Further, the present invention provides a system to enforce the temporal and purpose-based constraints automatically. For example, a celebrity's AI persona might be licensed to endorse a product, but the system ensures that this specific “endorsement capability” is active only for the campaign duration and only within the agreed context, after which it's automatically revoked or the specific learned behavior related to that campaign is securely archived/deleted from the active agent. This granular lifecycle control for parts of an agent or its data access is novel.

Further, the system learns from an interaction, logs it securely, uses that log to create a better agent, and the process of creating that better agent (including data access during replay) is itself governed by the enclave's rules. This holistic, secure, and adaptive learning architecture is a powerful inventive concept.

In addition, the inventive method lies in how the system processes the historical multi-layered data to identify leading indicators or patterns that allow newly trained agents to anticipate needs, suggest solutions before a problem fully manifests, or adapt their behavior based on subtle cues that previously required explicit user intervention. This moves beyond reactive AI to a more anticipatory form.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for transferring artificial intelligence (AI) agents. Transferable AI agents include inherent adaptability, which allows them to seamlessly transfer between different contexts and environments at any point during their training or deployment. By generating inferences and insights for other agents, they can significantly reduce the workload of both other AI agents and human operators. Collaborative problem-solving is facilitated by transferable AI agents. The present disclosure enables transfer of the agent at any point in training of the agent. The present disclosure may allow usage of agents to generate inferences alone for other agents.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

1. A method for managing collaboration of a plurality of Artificial Intelligent (AI) agents within a secure cloud-based enclave, comprising:
receiving, by an AI agent of the plurality of AI agents, a collaboration request to communicate with a transfer AI agent within the secure cloud-based enclave, wherein the collaboration request comprises initial parameters and a state of the AI agent;
logging, by the AI agent, the collaboration request with the initial parameters and the state of the AI agent in a database associated with the secure cloud-based enclave;
transmitting, by the AI agent, the collaboration request with data and context to the transfer AI agent within the secure cloud-based enclave;
adapting, by the transfer AI agent, operational context associated with the collaboration request to register accessed knowledge sources and configuration changes;
analysing, by the transfer AI agent using a first AI model deployed within the secure cloud-based enclave, the data and the context associated with the collaboration request to generate inferences and potential solutions;
transmitting, by the transfer AI agent, the generated inferences and potential solutions to the AI agent in response to the collaboration request; and
executing, by the AI agent, an action to the collaboration request based on the generated inferences and potential solutions.

2. The method according to claim 1, wherein the data and context associated with the collaboration request comprise data packets, metadata, sender/receiver identifiers, and timestamps.

3. The method according to claim 1, further comprising:
obtaining, by the transfer AI agent, input from one or more users based on an external interaction, wherein the input from the one or more users comprises at least one of a feedback, adjustments, and final decision related to the collaboration request; and
fine-tuning, by the transfer AI agent, the inferences and potential solutions based on the input obtained from the one or more users.

4. The method according to claim 1, further comprising:
obtaining, by the transfer AI agent, accumulated multi-layered historical logs from the database associated with secure cloud-based enclave, wherein the accumulated multi-layered historical logs comprise at least one of facts, inferences, behavioural data, and feedback loops obtained from past interactions; and
fine-tuning, by the transfer AI agent, the inferences and potential solutions based on the accumulated multi-layered historical logs.

5. The method according to claim 1, further comprising:
deploying a second AI model along with the first AI model within the secure cloud-based enclave;
analysing, by the transfer AI agent using the second AI model, the data and the context associated with the collaboration request to generate the inferences and potential solutions;
comparing performance of the second AI model with performance of the first AI model based on an analysis of results generated by the second AI model and the first AI model; and
prioritizing the second AI model over the first AI model based on a determination the performance of the second AI model is better than the performance of the first AI model.

6. The method according to claim 1, further comprising:
identifying a redundant AI agent from the plurality of AI agents based on performance of each AI agent of the plurality of AI agents;
archiving knowledge and critical interaction history from the redundant AI agent; and
deconstructing the redundant AI agent from the plurality of AI agents after archiving knowledge and critical interaction history from the redundant AI agent.

7. The method according to claim 1, wherein the secure cloud-based enclave securely retains the user data within the database without directly exposing to an external AI system.

8. A system for managing collaboration of a plurality of Artificial Intelligent (AI) agents within a secure cloud-based enclave, comprising:
one or more processors associated with a plurality of AI agents; and
a memory storing programmed instructions executable by the one or more processors, wherein the one or more processors execute the programmed instructions to:
receive, by an AI agent of the plurality of AI agents, a collaboration request to communicate with a transfer AI agent within the secure cloud-based enclave, wherein the collaboration request comprises initial parameters and a state of the AI agent;
log, by the AI agent, the collaboration request with the initial parameters and the state of the AI agent in a database associated with the secure cloud-based enclave;
transmit, by the AI agent, the collaboration request with data and context to the transfer AI agent within the secure cloud-based enclave;
adapt, by the transfer AI agent, operational context associated with the collaboration request to register accessed knowledge sources and configuration changes;
analyse, by the transfer AI agent using a first AI model deployed within the secure cloud-based enclave, the data and the context associated with the collaboration request to generate inferences and potential solutions;
transmit, by the transfer AI agent, the generated inferences and potential solutions to the AI agent in response to the collaboration request; and
execute, by the AI agent, an action to the collaboration request based on the generated inferences and potential solutions.

9. The system according to claim 8, wherein the data and context associated with the collaboration request comprise data packets, metadata, sender/receiver identifiers, and timestamps.

10. The system according to claim 8, wherein the one or more processors are further configured to:
obtain, by the transfer AI agent, input from one or more users based on an external interaction, wherein the input from the one or more users comprises at least one of a feedback, adjustments, and final decision related to the collaboration request; and
fine-tune, by the transfer AI agent, the inferences and potential solutions based on the input obtained from the one or more users.

11. The system according to claim 8, wherein the one or more processors are further configured to:
obtain, by the transfer AI agent, accumulated multi-layered historical logs from the database associated with secure cloud-based enclave, wherein the accumulated multi-layered historical logs comprise at least one of facts, inferences, behavioural data, and feedback loops obtained from past interactions; and
fine-tune, by the transfer AI agent, the inferences and potential solutions based on the accumulated multi-layered historical logs.

12. The system according to claim 8, wherein the one or more processors are further configured to:
deploying a second AI model along with the first AI model within the secure cloud-based enclave;
analysing, by the transfer AI agent using the second AI model, the data and the context associated with the collaboration request to generate the inferences and potential solutions;
comparing performance of the second AI model with performance of the first AI model based on an analysis of results generated by the second AI model and the first AI model; and
prioritizing the second AI model over the first AI model based on a determination the performance of the second AI model is better than the performance of the first AI model.

13. The system according to claim 8, wherein the one or more processors are further configured to:
identifying a redundant AI agent from the plurality of AI agents based on performance of each AI agent of the plurality of AI agents;
archiving knowledge and critical interaction history from the redundant AI agent; and
deconstructing the redundant AI agent from the plurality of AI agents after archiving knowledge and critical interaction history from the redundant AI agent.

14. The system according to claim 8, wherein the secure cloud-based enclave securely retains the user data within the database without directly exposing to an external AI system.

15. A non-transitory machine-readable medium including data, which when used by a system for managing collaboration of a plurality of Artificial Intelligent (AI) agents within a secure cloud-based enclave, causes the system to perform instructions that cause the system to perform operations comprising:
receiving, by an AI agent of the plurality of AI agents, a collaboration request to communicate with a transfer AI agent within the secure cloud-based enclave, wherein the collaboration request comprises initial parameters and a state of the AI agent;
logging, by the AI agent, the collaboration request with the initial parameters and the state of the AI agent in a database associated with the secure cloud-based enclave;
transmitting, by the AI agent, the collaboration request with data and context to the transfer AI agent within the secure cloud-based enclave;
adapting, by the transfer AI agent, operational context associated with the collaboration request to register accessed knowledge sources and configuration changes;
analysing, by the transfer AI agent using a first AI model deployed within the secure cloud-based enclave, the data and the context associated with the collaboration request to generate inferences and potential solutions;
transmitting, by the transfer AI agent, the generated inferences and potential solutions to the AI agent in response to the collaboration request; and
executing, by the AI agent, an action to the collaboration request based on the generated inferences and potential solutions.
